(19) United States
(12) Patent Application Publication
(10) Pub. No.: US 2006/0154718 A1
(43) Pub. Date: Jul. 13, 2006

(54) Method, apparatus, and program product for providing access to progressive prizes in a gaming system

(75) Inventors: Rodney L. Willyard, Flower Mound, TX (US); Naveen Malhotra, Murphy, TX (US); Feng Li, Plano, TX (US); Keith Riggs, Frisco, TX (US); Yuhua Li, Plano, TX (US)

Correspondence Address: THE CULBERTSON GROUP, P.C., 1114 LOST CREEK BLVD., SUITE 420, AUSTIN, TX, 78746, US

(73) Assignee: Multimedia Games, Inc.

(21) Appl. No.: 11/034,155

(22) Filed: Jan. 12, 2005

(51) Int. Cl. A63F 13/00

(52) U.S. Cl. 463/25

(57) ABSTRACT

A method employs a database table that contains progressive prize pool status data for each progressive game that may be available in a given gaming system. Additional database tables store definitions for both contributions to the various progressive prize pools and awards to be made from the various progressive prize pools. A given game play request in the gaming system is identified with a particular contribution definition from the applicable database table in order to properly update the applicable progressive prize pool in view of the game play request and the wager associated with that game play request. Also, a given result in a game offered through the gaming system is identified with a particular award definition in order to identify when a progressive prize is to be awarded and to properly award the applicable progressive prize and update the progressive prize pool.

### TECHNICAL FIELD OF THE INVENTION

The present invention relates to gaming systems that provide progressive games. More particularly, the invention is directed to a method for enabling different games and game presentation types to participate in progressive games.

### BACKGROUND OF THE INVENTION

Gaming machines give a player the opportunity to make a wager in return for a chance at some prize. Examples of gaming machines are traditional reel-type gaming machines (also known as “slot machines”) and the more modern video slot machines that use a video display to imitate the spinning reels of traditional slot machines. Various types of video poker gaming machines have also been developed to allow players to place wagers and participate in card games. The graphic presentations available in gaming machines and the manner in which graphics were presented in gaming machines proliferated in the 1980's and 1990's as technological advances allowed various features to be added to gaming machines and combined with other features to provide higher entertainment value for the player. The type of graphic presentation provided by a gaming machine, together with the various features of the graphic presentation, the type of game portrayed in the graphic presentation, and the player interface features and procedures employed by the gaming machine, may be referred to as the “game presentation” of the gaming machine.

The types of games offered through gaming machines also proliferated in the 1980's and 1990's. The traditional casino slot machines were stand-alone gaming machines in which the result for a given wager at the machine was determined by some arrangement at the gaming machine itself. Gaming machines are now used to allow players to participate in lottery games in which each wager effectively purchases a predefined electronic lottery ticket from a set of such electronic lottery tickets. The purchasing/wagering player receives the predetermined prize associated with the electronic lottery ticket that they have purchased through the video lottery gaming device. Gaming machines are also now used to allow players to participate in bingo games in which a player submits an electronic representation of a bingo card and the submitted card is compared against a random sequence of designations (a ball draw). Players achieving certain “winning” patterns of matched locations with their electronic bingo card representations are awarded prizes through these electronic bingo gaming machines. Lottery games, bingo games, card games, and traditional casino slot machine games are examples of types of games (also referred to herein as “game types”) that may be offered through modern gaming machines. It will be noted that bingo and lottery type games may be offered through video gaming machines that show the results as traditional casino game results, such as slot machine results for example. That is, a bingo or lottery type game may be played through a gaming machine offering a slot machine-type or other game presentation.

Many participants in wagering games prefer to participate in games that provide a chance at a large prize or payout. Thus, game designers have strived to develop games that give a player the chance at a large prize, but still maintain an acceptable return for the entity offering the game (the “game operator”). One popular method of giving players a chance at a large prize in a game is to allot a portion of the wagers made in a game to a prize pool, and then award a large prize from the pool on the occurrence of some triggering event. These types of games are commonly referred to as “progressive” games. In these progressive games, numerous gaming machines may be linked so that a portion of the wager from each gaming machine is allotted to a given progressive prize pool. By linking large numbers of gaming machines in this fashion, many different wagers may contribute to the progressive pool. This may allow the progressive pool to grow rapidly and may allow the game operator to offer very large progressive prizes in addition to, or in lieu of, the normal prizes offered for a given game.

Although progressive games are popular with players, they add a layer of complexity for the game operator. Progressive games require an arrangement for tracking the wagers made in a game and for tracking the contributions to the progressive pool. The wager and contribution data from different gaming machines participating in the same progressive game must be combined and stored so that the progressive prize or prizes may be awarded upon the occurrence of the desired triggering events. Prior progressive gaming systems have defined progressive games on a game-by-game basis, with a given progressive game being defined for a particular game presentation and given game type. For example, a progressive game may be defined for a given slot-machine type game offering a given game presentation so that only gaming machines offering this game type and game presentation may contribute to the defined progressive pool. This type of progressive game definition limits the progressive pools that may be collected. The only way to increase the rate at which the progressive pool is incremented using this type of progressive game definition is to provide more of the specific type of gaming machine. However, the ability to simply add more gaming machines of a give type is limited in an environment where players demand a large selection of game types and game presentations.

### SUMMARY OF THE INVENTION

The present invention encompasses a flexible process for providing progressive games in a gaming system. More particularly, the present invention encompasses a process of providing progressive games in which gaming machines offering different game types, different game presentations, and even different wager denominations may contribute to a common progressive prize pool, and in which gaming machines offering the same game type and same game presentation may participate in different progressive prize pools. The invention also encompasses gaming systems and program products for implementing the progressive prize handling methods.

A method according to the present invention employs a database arrangement, that is, a database table or some other data structure, that contains progressive prize pool status data for each progressive game that may be available in a given gaming system. Additional database arrangements are preferably used to store definitions for both contributions to the various progressive prize pools and awards to be made from the various progressive prize pools. A given game play request in the gaming system is identified with a particular contribution definition from the applicable database arrangement in order to properly update the applicable progressive prize pool in view of the game play request and in view of the wager associated with that game play request. Also, a given result in a game offered through the gaming system is identified with a particular award definition in order to identify when a progressive prize is to be awarded and to properly award the applicable progressive prize and update the progressive prize pool. This arrangement for contributing to and drawing from the progressive prize pools allows great flexibility in the gaming system. In particular, the arrangement allows gaming machines offering different game presentations and even entirely different game types to contribute to, and draw from, a common progressive prize pool. The arrangement also allows gaming machines offering the same game type and game presentation to participate in different progressive prize pools.

One method embodying the principles of the invention includes storing a number of contribution definitions where each respective contribution definition is associated with a respective progressive prize pool included in a number of progressive prize pools. The method also includes identifying a particular one of the contribution definitions (a first contribution definition) included in the number of contribution definitions. This first contribution definition is correlated to a particular game play request (a first game play request) in the gaming system. The invention applies the first contribution definition to update the respective progressive prize pool associated with the first contribution definition.

A method embodying the principles of the invention may also include storing a number of award definitions, where each respective award definition is associated with a respective progressive prize pool included in a number of progressive prize pools. A particular one of these award definitions (a first award definition) may be identified based on a correlation with a particular game result (first game result). The method includes applying the first award definition to assign a first prize from the progressive prize pool associated with the first award definition and further includes applying the first award definition to update that progressive prize pool in light of the assigned prize.

One preferred gaming system embodying the principles of the invention includes a number of player stations (that is, gaming machines), a database data processing system (which may be referred to herein as a “database system”), and a game processing system. The database system stores a number of progressive prize pool entries, a number of contribution definitions, and a number of award definitions. Each contribution definition and each award definition is associated with a respective one of the progressive prize pool entries, preferably through a common prize pool identifier (which may also be referred to as a “prize pool name”). The game processing system receives a particular game play request (a first game play request) from one of the player stations (a first player station) and interfaces with the database system to identify the particular contribution definition correlated to the first game play request to apply that first contribution definition to update its associated progressive prize pool entry. The game processing system in this form of the invention also identifies a game result for the first game play request and interfaces with the database system to identify the game result with a particular one of the award definitions (a first award definition) and to apply the first award definition to assign a prize from the progressive prize pool that is associated with the first award definition. The game processing system also applies the first award definition to update the associated progressive prize pool.

The invention further encompasses a program product that is executable to configure the system processing devices to perform the methods and functions according to the invention. In particular, one program product embodying the principles of the invention includes prize database program code and prize manager program code. The prize database program code is executable to store the above described contribution definitions, award definitions, and progressive prize pools entries. The prize manager program code is executable to identify a respective game play request with a respective one of the contribution definitions and to apply that contribution definition to update the respective progressive prize pool. The prize manager program code is also executable to identify a particular game result with a respective one of the award definitions and to apply that award definition to assign a prize from the associated progressive prize pool, and to update that progressive prize pool.

These and other advantages and features of the invention will be apparent from the following description of the preferred embodiments, considered along with the accompanying drawings.

### BRIEF DESCRIPTION OF THE DRAWINGS

FIG. 1 is a diagrammatic representation of a gaming system embodying the present invention.

FIG. 2 is a diagrammatic representation of a computer system that may be used for various components of the gaming system shown in FIG. 1.

FIG. 3 is a diagrammatic representation showing further details of a player station that may be used in the gaming system shown in FIG. 1.

FIG. 4 is a diagrammatic representation showing processes that are performed by the various processing devices of the gaming system shown in FIG. 1.

FIG. 5 is a diagrammatic representation of a series of data tables employed at a respective gaming site in one preferred form of the present invention.

FIG. 6 is a diagrammatic representation of a series of data tables employed at a central system in one preferred form of the present invention.

FIG. 7 is a flow chart showing one preferred method for processing progressive prize pool contributions according to the present invention.

FIG. 8 is a flow chart showing one preferred method for awarding progressive prizes according to the present invention.

### DESCRIPTION OF PREFERRED EMBODIMENTS

The claims at the end of this application set out novel features which the Applicants believe are characteristic of the invention. The various advantages and features of the invention together with preferred modes of use of the invention will best be understood by reference to the following description of illustrative embodiments read in conjunction with the drawings introduced above.

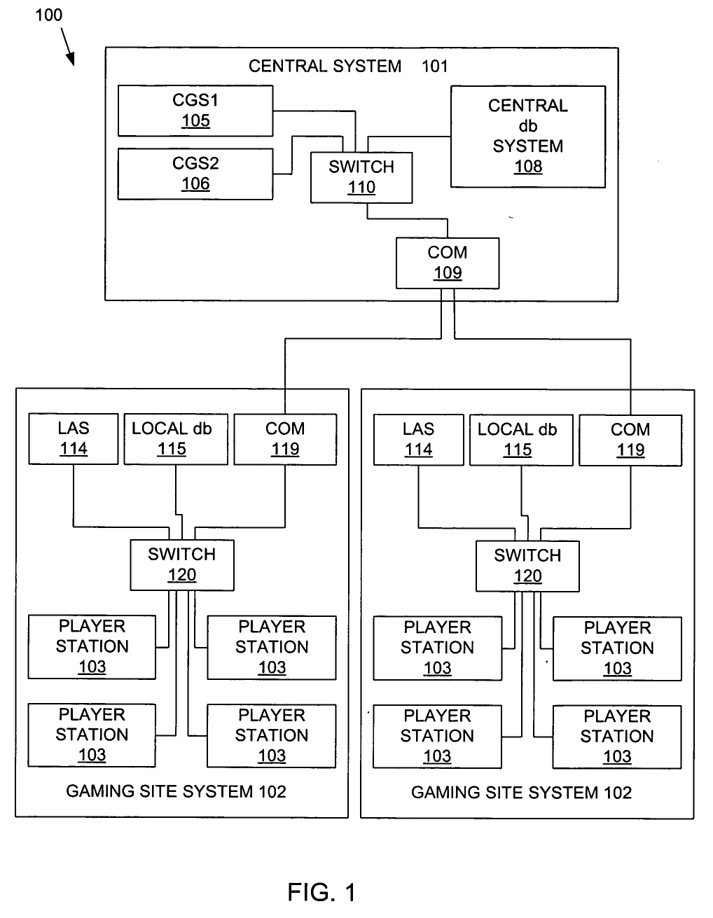

FIG. 1 shows a gaming system 100 embodying the principles of the present invention. Gaming system 100 includes a central system 101 and a number of different gaming site systems 102. Each of the gaming site systems 102 includes a number of player stations 103 through which players may participate in games, including progressive games, offered through gaming system 100. In a preferred implementation of gaming system 100, a player causes a game play request to be initiated through a respective player station 103 and a component at central system 101 or at the respective gaming site system 102 identifies a result for the game play request. This result for the game play request is ultimately returned to the player station 103 which initiated the game play request, so that the player station can reveal the result to the player. According to the present invention, some of the results entitle the player to a progressive prize.

Central system 101 includes a first central game server (CGS1) 105 and a second central game server (CGS2) 106. The central system 101 illustrated in FIG. 1 also includes a central database system 108 and a communications interface 109 all connected to a switching hub 110.

Each central game server 105 and 106 preferably comprises a separate processing system that is programmed with suitable operational program code or is otherwise configured to serve as a game processing system to conduct games in gaming system 100. That is, each central game server 105 an 106 is adapted to receive a respective game play request and identify a result for the game play request. Two different central game servers 105 and 106 are shown in FIG. 1 to indicate that system 100 may provide two entirely different game types. For example, first central game server 105 may be configured to collect bingo game play requests and conduct bingo games according to certain bingo rules, while second central game server 106 may be configured to collect game play requests for, and conduct, various types of card games. As another example, first central game server 105 may be configured to collect game play requests and conduct bingo games under a first set of bingo rules and second central server 106 may be configured to collect game play requests and conduct bingo games under an entirely different set of bingo rules.

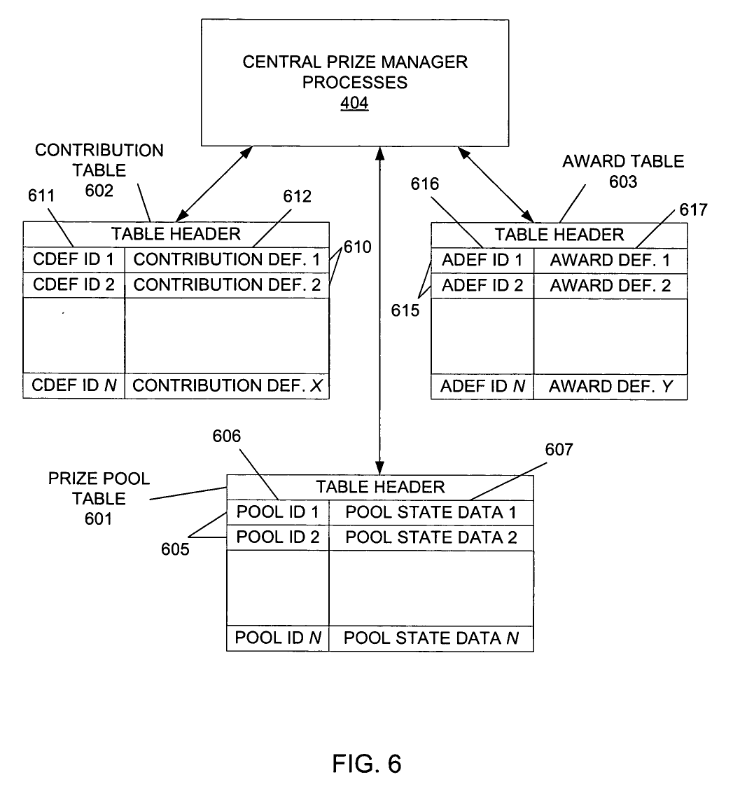

Central database system 108 preferably comprises a separate data processing system that is responsible for providing database processes for use by the central game servers 105 and 106, and perhaps other components at central system 101. In particular, central database system 108 maintains data structures such as database tables for example that are used according to the present invention to provide progressive prizes through gaming system 100. This arrangement of data structures for use in providing progressive prizes will be described in further detail with reference to FIG. 6.

Communications interface 109 facilitates communications between central system 101 and each gaming site system 102. In one preferred form of the invention, communications interface 109 comprises an Internet router or similar device which serves as an interface between the components of central system 101 and the Internet which provides a communications link to the different gaming site systems 102. However, gaming system 100 is not limited to any particular type of communications link between central system 101 and gaming site systems 102, and is not limited to any particular type of communications protocol. For example, a suitable wireless communications link may be provided between central system 101 and each gaming site system 102. In any case, preferred forms of the invention may include a primary communications interface and link and a secondary or backup communications interface and link even though only a single communications interface 109 and link is shown in FIG. 1.

All of the components shown in FIG. 1 at central gaming system 101 are connected to switching hub 110. Switching hub 110 comprises a suitable device that facilitates communications between the various other components of central system 101. For example, the first and second central game servers, 105 and 106, respectively, may require access to data stored in data tables at central database system 108 in the course of conducting various games in gaming system 100. The communications between the respective cental game server 105 or 106 and central database system 108 are routed through switching hub 110. Communications to and from communications interface 109 are also handled through switching hub 110 in the system configuration shown for central system 101 in FIG. 1.

In addition to the various player stations 103, each gaming site system 102 includes at least one local area server 114, a local database system 115, and a communications interface 119. All of these components are connected together through a switching hub 120. Although FIG. 1 shows only two different gaming site systems 102, it will be appreciated that a gaming system embodying the principles of invention may include a large number of different gaming site systems. These gaming site systems would typically correspond to the different casinos at which games are offered. These different casinos may be far removed from central system 101. Regardless of whether the gaming site systems 102 represent different casinos or otherwise, the present invention encompasses any number of gaming site systems and is by no means limited to a gaming system including only two gaming site systems such as that shown for exemplary purposes in FIG. 1. Also, although only four player stations 103 are shown in the illustrated example for each gaming site system 102, the invention is not limited to any particular number of player stations, either at a single gaming site or across the entire gaming system 100. A given gaming system according to the invention may encompass thousands of player stations.

Local area server 114 preferably comprises a separate data processing system that serves as a link between the various player stations 103 and the respective central game server 105 or 106 that conducts games for the respective player station. In particular, local area server 114 may receive a game play request initiated through a player station 103 at the respective gaming site system 102, and relay that game play request to the appropriate central game server 105 or 106 at central system 101. Local area server 114 may also receive the result identified at the respective central game server 105 or 106, communicate with local database 115 as necessary, and then communicate with the player station 103 associated with the given result so that the player station can reveal the result to the player together with any prize associated with the result. In some gaming systems employing the present invention, each local area server 114 may implement a game processing system for identifying game results locally without having to have games conducted at a central game server such as central game server 105 or 106. Some gaming systems may accommodate both locally conducted games in which results for some games are identified at a game processing system at the gaming site system 102 and centrally conducted games in which results for some games are identified at a game processing system at central gaming system 101.

Local database system 115 preferably comprises a separate data processing system that is programed or otherwise configured to provide database processes for the particular gaming site system 102. In particular, local database system 115 stores data structures used to implement progressive games in gaming system 100. Local database system 115 may also store data structures used for identifying or correlating results and prizes in non-progressive games offered through gaming system 100. A player account-based or session account-based accounting system employed in gaming system 100 may also be implemented using various data structures stored and maintained at local database system 115.

Communications interface 119 comprises a device that provides a function similar to that provided by communications interface 109 associated with central system 101. In one preferred gaming system 100, communications interface 119 may comprise a router that provides an interface between the respective gaming site system 102 and the Internet over which communications are carried between the respective gaming site and central system 101. As discussed above with respect to communications interface 109, communications interface 119 associated with each respective gaming site system 102 may comprise any interface suitable for the respective communication link between the central system 101 and respective gaming site system 102. Redundant communications interface devices corresponding to device 119 may be provided at each gaming site system 102 for use as a secondary or backup communications interface over a different communications link in the event of a failure of the primary communications link.

The gaming system 100 shown in FIG. 1 is shown only for purposes of example and is not intended to be the sole type of the gaming system in which the present invention may be implemented. Among the numerous variations in a gaming system implementing the present invention, the respective gaming sites 102 may include numerous additional devices or components for performing various additional functions employed in the gaming system. For example, each gaming site system 102 may include a validation terminal through which players may open or close player accounts, or trade gaming system credit vouchers for cash or other value. Each gaming site system may also include a separate data processing system connected to switching hub 120 to provide gaming system operator access to the gaming system for various purposes, such as for generating reports, monitoring system activity, or configuring progressing and non-progressive games. Central system 101 may also include a separate data processing system connected through switching hub 110 to provide system operator access for reporting, setup, maintenance, or other purposes. Other variations in a gaming system according to the present invention may involve the system topography. For example, even where gaming system 100 conducts more than one type of game, only a single central game server may be used in place of the separate central game servers 105 and 106 to conduct the games. Also, the central game server or servers may be configured to provide the database processes provided by central database system in the example gaming system 100. Each local area server 114 may similarly be configured to provide the local database processes that are provided through the separate database system 115 in the example gaming system 100. Different local area network arrangements may be employed between various components in central system 101 and in each gaming site system 102. Other forms of the invention may, for example, use an alternative to the hub and spoke network arrangement shown in FIG. 1. The player stations 103 also need not connect directly to the gaming system 100 as shown in FIG. 1. Rather, a group of player stations 103 may be connected in a chain terminating in a suitable controller for providing an interface to the respective gaming site system. This sort of communication arrangement could employ RS-485 communications from the player stations 103 to the controller for example. In yet other forms of the invention, some player stations 103 at a given gaming site system 102 could be connected directly to the system as shown in FIG. 1 and other player stations 103 at the site might be connected through a RS-485 controller. The invention encompasses these and any other suitable topographies at central system 101 and each gaming site system 102.

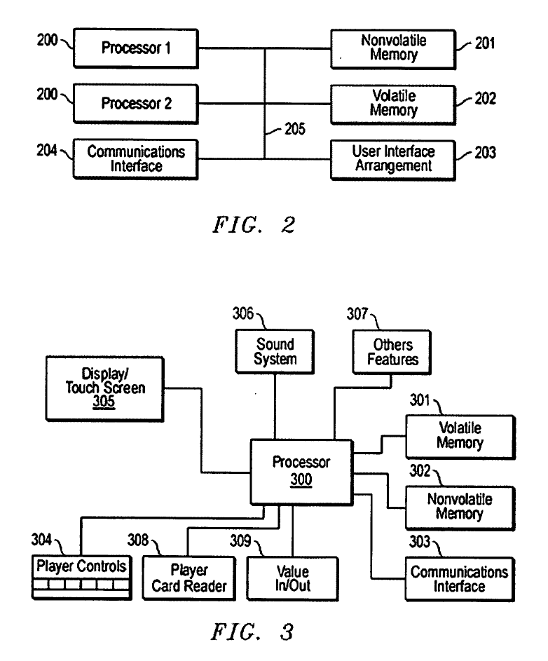

Each central game server 105 or 106, central database server 108, and each local area server 114 and local database system 115 included in gaming system 100 as shown in FIG. 1 may comprise a computer system having the basic structure shown in FIG. 2. That is, each of these components from gaming system 100 may include one or more processors 200, nonvolatile memory 201, volatile memory 202, a user interface arrangement 203, and a communications interface 204 all connected to system bus 205. Of course, there may be many variations from this basic structure. For example, alternatively to the integrated user interface 203 shown in FIG. 2, the user interface for the respective system component may be provided through a separate computer such as a management terminal included in the respective system 101 or 102. It will also be appreciated that the preferred data processing system structure shown in FIG. 2 comprises a structure for a general purpose processing device such as a personal computer. In embodiments of the invention that use these types of data processing systems, the various functions or operations performed by the processing devices are performed under the control of operational program code executed at the processing device. However, the invention is not limited to these general purpose processing devices. Rather, data processing systems according to the present invention may comprise special purpose processing devices that are configured to perform the desired operations.

FIG. 3 shows an example of a player station 103 that may be used in a gaming system embodying the principles of the present invention. The illustrated player station 103 includes a processor 300, volatile memory 301, nonvolatile memory 302, and a communications interface 303. The volatile and nonvolatile memory stores computer program code that may be executed by processor 300 to cause the processor to perform or direct the various functions provided by player station 103. Communications interface 303 allows communications between player station 103 and the local area server 114 or other components of system 101. Player station 103 also includes a special user interface arrangement to facilitate player participation in the game or games offered through that particular player station, and display results in an exciting and attractive format. This interface includes player controls 304, a display device or touch screen display 305, a sound system 306, and perhaps other features 307 such as alarms or special displays or alerting devices. Each player station 103 also preferably includes a convenient system for allowing the player to input player-specific information and for receiving wagers and dispensing winnings. For example, the player station 103 shown in FIG. 3 includes a player card reader 308 that is adapted to read player-specific information from a player account card inserted into the reader. A player account card may, for example, include player information or simply a player identifier encoded on a magnetic medium (mag stripe) associated with the card, or encoded on a bar code, or a memory device associated with the player account card. The illustrated player station 103 also includes a device 309 for receiving value and issuing value in the course of play. This device may accept currency, vouchers, or tokens, for example, and also output currency, vouchers, or tokens. Of course, a separate device may be used to receive and issue value for games played according to the present invention. Alternatively, or in addition to value in/out device 309, player stations 103 may read player account information from the player account card or from player information otherwise input at the player station, and may account for wagers and winnings in the manner set out in U.S. Patent Application Publication No. 2002/0132666 A1, entitled “Distributed Account Based Gaming System.”

The particular player station configuration shown in FIG. 3 is shown only for purposes of example. The invention is not limited to any particular player station type or configuration. In particular, the present invention facilitates using different types of player stations 103, but allows these different types of player stations to contribute to and draw from a common progressive prize pool. Also, the invention is particularly useful for gaming systems that employ configurable player stations that may offer two or more alternative game presentations or even alternate game types. Also, as with the other processing devices employed in gaming system 100, the processor 300 associated with a player station need not be a general purpose processor. Rather, all of the required processing may be provided with special purpose processing circuitry.

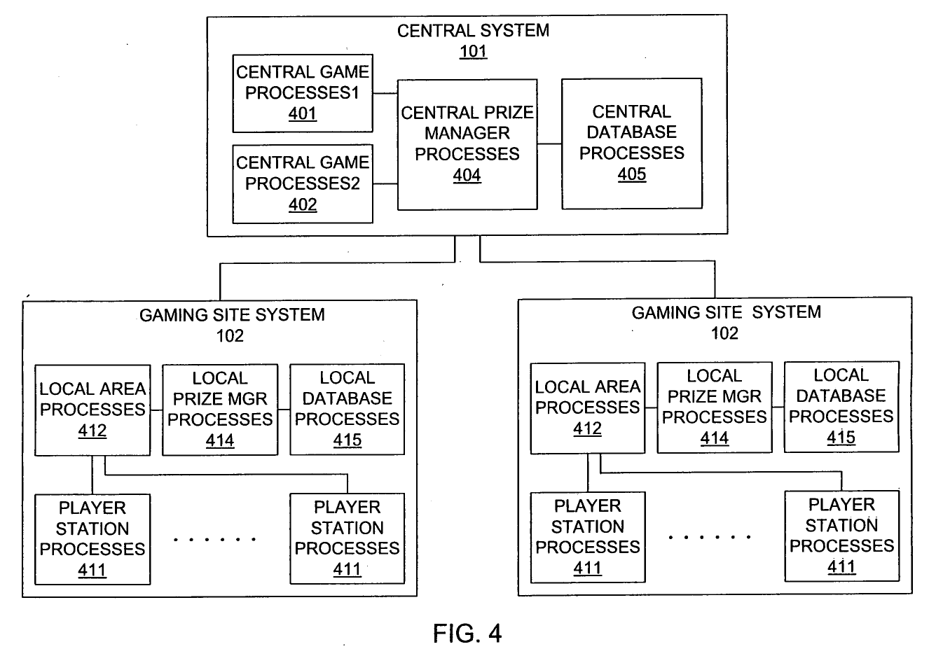

FIG. 4 is a diagram representing a number of processes (which may also be referred to as “services”) utilized in gaming system 100 shown in FIG. 1. These processes are shown in FIG. 4 in relation to the physical location at which the processes are performed in the form of the invention shown in FIG. 1.

The processes performed at central system 101 include first central game processes 401, second central game processes 402, central prize manager processes 404, and central database processes 405. First central game processes 401 are preferably performed at a suitable processing device such as first central game server 105 shown in FIG. 1. Similarly, second central game processes 402 are preferably performed by a separate processing device such as second central game server 106 in FIG. 1. These first and second central game processes include all of the processes required to conduct the respective game for a given game play request or group of game play requests initiated through the various system player stations (103 in FIG. 1). For example, first central game processes 401 may include processes to receive and group game play requests for bingo games, and then conduct bingo games between the grouped game play requests. In this bingo game example, these processes may be similar to those described in U.S. Patent Publication No. 2004-0152499-A1 entitled “Method, System, and Program Product for Conducting Multiple Concurrent Bingo-Type Games.” Continuing on with this example, second central game processes 402 may include processes for grouping game play requests for card games and conducting card games as described in U.S. patent application Ser. No. ______ entitled “Method and System for Conducting Card Games” and filed Dec. 23, 2004.

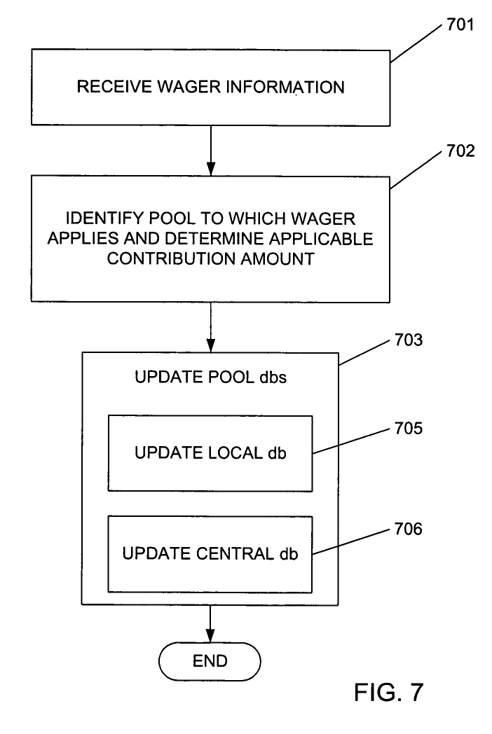

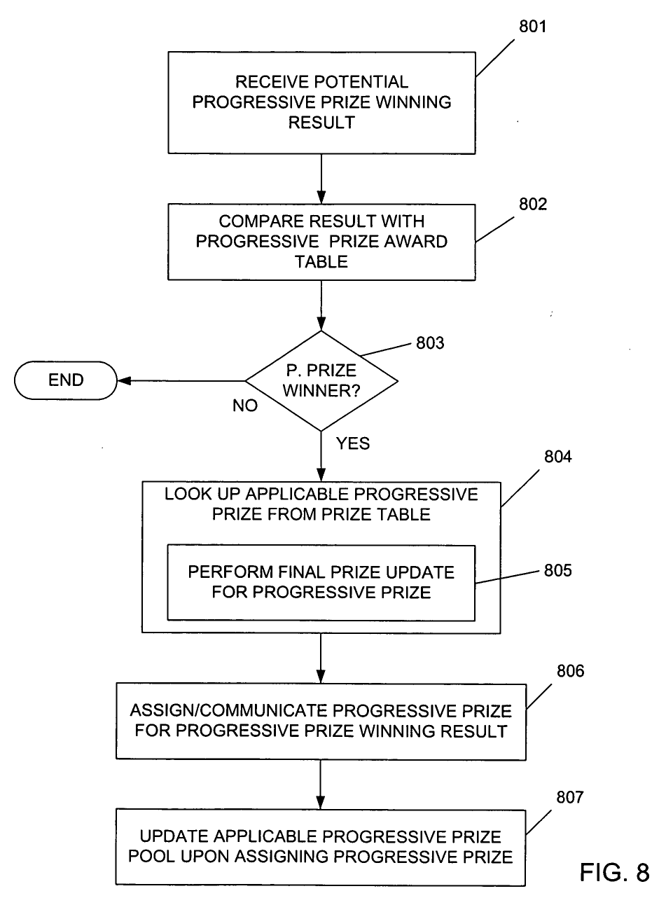

Central database processes 405 are preferably performed through a separate processing device such as central database system 108 shown in FIG. 1. These central database processes 405 include all of the processes required to store and maintain the various data structures used by other processes at central system 101. For the present progressive gaming invention, central database processes 405 include those processes necessary for storing and maintaining the progressive prize-related data structures described below with reference to FIG. 6 and with reference to the process flow charts shown in FIGS. 7 and 8.

FIG. 4 shows central prize manager processes 404 interposed between the central game processes 405 and central database processes 401 and 402. These prize manager processes 404 serve as an interface between the central game processes 401 and 402, and the data stored through the central database processes 405 in order to provide the progressive games according to the present convention. Where the prize manager processes 404 are performed through general purpose processing devices, these processes may in fact be performed partially at the central game servers 105 and 106 shown in FIG. 1 and partially at the central database system 108 under the control of operational program code which may be referred to as central prize manager program code.

The processes performed at each gaming site system 102 include player station processes 411, local area server processes 412, local prize manager processes 414, and local database processes 415. Player station processes 411 include those processes performed through the player stations (103 in FIG. 1) to initiate game play requests in response to player inputs and communicate the game play requests to the initial game play request receiving component of the system, preferably local area server 114 shown in FIG. 1. The player station processes 411 also receive information regarding the result for the game play request and prize information in order to reveal the result and any associated prize to the player at the player station, including any progressive prize that may be assigned according to the invention.

Local area server processes 412 include those processes used to receive and process game play requests initiated at the player stations (103 in FIG. 1) through player station processes 411. In some preferred forms of the present invention, this includes identifying the incoming game play request with a particular game and forwarding information from the game play request to the appropriate central game server (105 or 106 in FIG. 1) which preforms the required central game processes 401 or 402 for the game play request. Local area server processes 412 also include those processes required to receive the result for a given game play request from the appropriate central game server and communicate the required result and prize information to the appropriate player station 103 (FIG. 1). In particular, local area server processes 412 are responsible for matching game play requests with returned results so that the correct result information is conveyed to the correct player station 103.

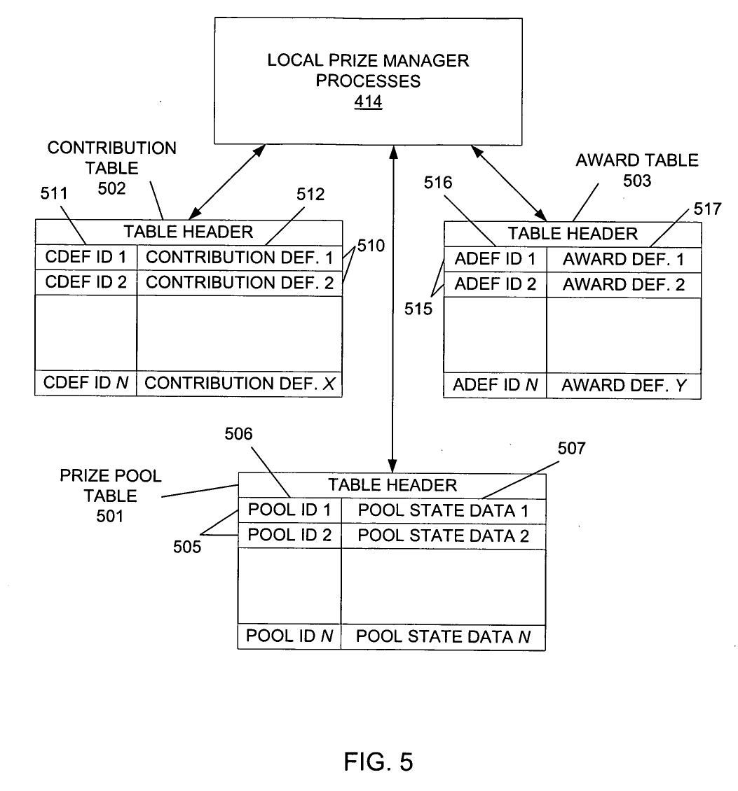

Local database services 415 include those services required to store and maintain the data structures required for use by the local area server processes 412. For providing progressive games according to the present invention, local database processes 415 may include processes for storing the progressive prize related data structures described below with reference to FIG. 5 and to the flow charts in FIGS. 7 and 8. Local database processes 415 may also include processes for storing and maintaining player account-related data and data related to player station status and activity. In any event, the local database processes 415 are preferably performed at a separate processing device at gaming site system 102 such as local database system 115 shown in FIG. 1.

Local prize manager processes 414 include processes that serve as an interface between the local area server processes 412 and the local database processes 415. In particular, local prize manager processes 414 allow the local area server processes 412 at the given gaming site system 102 to access the data required to determine the appropriate prize contributions to progressive prize pools according to the present invention. Also, local prize manager processes 414 enable the local area server processes 412 to access data required to check for a local or central progressive prize win and obtain the appropriate progressive prize value for a local win. Local prize manager processed 414 may be performed through program code executed at the local area server 114 of FIG. 1 and program code executed at the local database system 115.

In preferred forms of the invention in which general purpose processing devices are used to implement the various processing components of the gaming system 101 shown in FIG. 1, the program code executed to provide the database processes may be referred to as prize database program code. This prize database program code is executed to store and maintain the various data structures described below both at the central database system 108 and the local database systems 115. The program code executed to provide the central and local prize manager processes may be referred to as prize manager program code. Also, since the example gaming system 101 shown in FIG. 1 employs the same processing devices for performing some game processes and some prize manager processes and performs complementary functions at different processing devices, one or more of the processing components shown in FIG. 1 may be thought of as a single system for performing the various functions according to the present invention. For example, since separate processing devices, central database system 108 and a respective local database system 115 combine to store the data structures described in FIGS. 5 and 6, the combination of these separate processing devices may be considered a “database system” according to the present invention. Similarly, a respective central game server and local area server together may be considered a “game processing system” according to the present invention. It will be appreciated, however, that a gaming system according to the invention is not limited to the configuration shown in FIG. 1, and that a single processing component may be considered a database system, or a game processing system, or both.

FIG. 5 shows a series of data structures used to provide progressive games according to the present invention. The data structures illustrated in FIG. 5, which will be referred to as “tables” for convenience, include a progressive prize pool table 501, a contribution table 502, and an award table 503. In the following discussion, these progressive prize system tables will be described with reference to the example gaming system 100 shown in FIG. 1. However, it will be appreciated that the these types of tables may be employed with different types of gaming systems to provide progressive prizes according to the invention.

Progressive prize pool table 501 stores data used to define the state of each progressive prize pool used in the gaming system. Table 501 includes a number of entries 505, each entry dedicated to a respective progressive prize pool. Each entry 505 includes a pool ID field (pool name field) 506 and a pool state data field 507. An identifier stored in pool ID field 506 uniquely identifies the respective prize pool and data table entry so that the entry may be accessed as required. Pool state data field 507 stores all of the data required to define the state of the respective prize pool. In particular, prize pool state field 507 stores the current value, initial value, maximum value, type of pool, and any other data that may be required to define the state of the pool. It will be appreciated that although shown as a single field in the drawing, the different values stored to define the pool state may be stored in separate fields. The invention is not limited to any particular arrangement for storing the required prize pool state data in a given data table entry.

Contribution table 502 stores all of the data required to ensure each wager made in a progressive game is applied appropriately to the correct progressive prize pool. Table 502 includes a number of entries 510, each entry associated with a respective contribution definition. Each entry 510 includes two fields, an identifier field 511 (labeled CDEF ID 1, CDEF ID 2, etc.) and a contribution definition field 512. Identifier field 511 stores an identifier that uniquely identifies the respective entry so that the desired entry may be accessed in the processes described below. Field 512 in each contribution table entry 510 stores a contribution definition including all information required to determine how a given wager contributes to a respective progressive prize pool so that the progressive prize pool may be updated in response to a wager in the progressive game. In particular, the contribution definition in a given field 512 includes a prize pool identifier that associates the particular entry with a respective progressive prize pool to identify the progressive prize pool to which the contribution definition applies. The other information stored in field 512 will depend upon the nature of the respective progressive prize pool and how the pool is incremented by a wager. For example, a gaming system may maintain progressive prize pools either in terms of credits or some unit of currency (such as pennies). In these systems, field 512 may include an identifier indicating whether the contribution definition applies to a progressive prize pool expressed in credits or a pool maintained in a unit of currency. A contribution for a progressive prize pool maintained in pennies may be expressed simply as a percentage of the wager, and thus the entries 510 for these types of progressive prize pools may store the percentage to be applied to the wager to determine the contribution amount. In other arrangements an algorithm may be used to determine the contribution amount for a given wager, and the field 512 in these cases will store the algorithm to be applied. As with the pool state data field of the progressive prize pool table, the contribution definition field 512 may in fact be broken down into a number of different fields for storing the desired information.

Award table 503 stores information necessary to determine when a result in a particular game entitles the player to a progressive prize and may identify the progressive prize amount depending upon the nature of the progressive prize. Each award table entry 515 includes an identifier field 516 storing an award table entry identifier (labeled ADEF ID 1, ADEF ID 2, etc.) and an award definition field 517 which stores the award definition itself. This award definition field 517 may also be broken up into a number of separate fields rather than the single field shown in FIG. 5 and may include a number of elements. For example, an award definition for a bingo game may include a pattern identifier that identifies a pattern that must be achieved to win a progressive game prize, and may further include any other variations that may be used to distinguish between a progressive prize winning result and other results, such as the number of balls necessary to achieve the pattern (continuing with the bingo example) or the order of matches. Also, each progressive prize award definition stored in field 517 may include information regarding the progressive prize to be awarded. Some progressive prizes may be defined as some fixed amount. For this fixed amount type of progressive prize, the award definition stored at field 517 may include the fixed amount that makes up the prize. Other progressive prizes may be defined in terms of some algorithm. In these algorithm-defined prize cases, the award definition field 517 may include the algorithm and operand values for the algorithm. Perhaps the most common type of progressive prize is defined simply as an amount that has been collected in the given progressive prize pool at the time of the progressive game winning event. In these cases, the award definition stored at field 517 preferably does not include any progressive prize amount. Rather, the progressive prize value for these types of progressive prizes is obtained from the respective progressive prize pool table entries 505.

It will be noted that each of the entries in the contribution table 502 and award table 503 (entries 510 and 515 respectively) are correlated to a particular progressive prize pool and a particular entry 505 in progressive prize pool table 501. Each entry 510 and 515 preferably includes the progressive prize pool identifier for the progressive prize pool and progressive prize pool table entry 505 with which the respective contribution table entry or award table entry is associated. The progressive prize pools themselves are not necessary correlated to a particular game, although progressive prize pools representing a pot (in a card game for example) or a “must go” prize in a bingo game, may be associated with a particular prize pool. Because the present invention allows games to be separated from the progressive prize pools, a game conducted through a player station (103 in FIG. 1) may be defined as a progressive game by assigning the game to a particular progressive prize pool and providing a suitable contribution table entry for handling pool contributions and a suitable award table entry for handling pool prizes. Using the tables to access and maintain progressive prize pools according to the invention provides a great deal of flexibility in handling progressive prizes. For example, two identical player stations providing identical game presentations at a respective gaming site may contribute to, and draw progressive prizes from, entirely different progressive prize pools. Also different game presentations and even entirely different games may be defined as participating in a common progressive prize pool according to the present invention.

The present invention also allows progressive prize pools to be designated just for one or more particular game operators. For example, a gaming system such as that shown in FIG. 1 may include a large number of gaming system sites 102, where some of the sites are operated by one operator and other of the sites are operated by another operator. In this situation, the present invention allows a progressive game to be defined for a particular operator by assigning the appropriate contribution and award table definitions and associating those definitions with a common progressive prize pool.

Another advantage of the present invention employing the interrelated progressive game data is that games of different wager denominations may contribute to a common progressive prize pool. Where different denomination games contribute to a common progressive prize pool, the contribution amount, progressive prize amount, and progressive prize win definitions may all be set in the contribution, award, and prize pool data table entries to ensure that the games of different denominations fairly share the collected progressive prize pool. For example, a progressive win definition for a low denomination game may be defined in the award table entry for the game with relatively high odds as compared to a higher denomination game contributing to the same progressive prize pool, or the contribution amount for the low denomination game may be set at a relatively higher percentage, or both.

FIG. 5 shows particularly data tables stored at a given gaming site system 102 in the gaming system of FIG. 1, accessed through the local prize manager processes 414 shown in FIG. 4. The same types of tables, that is, a progressive prize pool table, a contribution table, and an award table are also preferably stored at the central database system 101 shown in FIG. 1. In fact, in one preferred form of the present invention, central database system 108 in FIG. 1 stores all data structures used in the system together with the required entries, and these entries are downloaded as necessary to the gaming site system 102 for storage in the respective local database system 115 at the gaming site. The respective data structures at the gaming sites may also be replicated at the central database system for backup or other purposes. However, there are differences between the respective progressive prize pool, contribution and award tables stored at central database system 108 and local database systems 115 in preferred forms of the invention as shown in FIG. 1. In particular, for system-wide progressive games, that is, games that receive contributions from player stations 103 at different gaming site systems 102 in FIG. 1, the pool state data in field 507 of a prize pool table entry 505 at a gaming site system may include just the contributions for wagers from that gaming site for a particular incremental period of time. This data for system-wide progressive games may be transferred to the corresponding progressive prize pool entries in a progressive prize pool table at central database system 108 to maintain the overall progressive prize pool value taking into account contributions from game play requests initiated through player stations all over gaming system 100. In other forms of the invention, since centralized progressive prize pool data is not necessary for maintaining the state of a progressive prize available only at a given gaming site system 102, the central data structures may not include any information on such purely local progressive prizes.

In any event, it will be appreciated that a similar configuration of data is maintained for the prize manager processes 404 (FIG. 4). FIG. 6 shows this separate set of tables associated with prize manager processes 404 implemented at central system 101. In particular, central progressive prize pool table 601 includes entries 605 each having a pool identifier field 606 and a pool state data field 607. Central contribution table 602 includes entries 610 each having a contribution identifier field 611 (CDEF ID 1, CDEF ID 2, etc.) and a contribution definition field 612. Central award table 603 includes entries 615 and each entry includes an award identifier filed 616 (ADEF ID 1, ADEF ID 2, etc.) and an award definition field 617.

Methods of providing progressive games and prizes according to the present invention may be divided into two broad method components. A first component of the method deals with making the appropriate contributions to the progressive prize pools in view of wagers submitted in the gaming system. This first component of the method may be described with reference to FIG. 7. A second component of the progressive gaming method deals with how prizes are awarded in the progressive games. This second component of the progressive gaming method may be described with reference to FIG. 8. In the discussions associated with both of these process flow charts FIGS. 7 and 8, reference will be made to various hardware components shown in FIG. 1 using the reference numerals shown in that figure. The reference numerals used below to identify data table features are shown in the respective FIGS. 5 and 6.

The process shown in FIG. 7 represents the process for a particular wager made in a progressive game offered through the gaming system 100. This process is invoked for each progressive game wager and represents processes performed by the local prize manager processes. The process of making contributions to the various progressive prize pools shown in FIG. 7 first includes receiving wager information as indicated a process block 701. The method then includes identifying the progressive prize pool to which the wager applies and determining the applicable contribution amount to be applied to the progressive prize pool as indicated at process block 702. The progressive prize pools are then updated as indicated at process block 703. This progressive prize pool updating process may include updating both the data tables stored at the respective gaming site system 102 with local database system 115 as shown at process block 705, and updating the data stored at central database system 108 as indicated at block 706. The contribution process shown in FIG. 7 ends for the given wager once the progressive prize pool or pools are updated for the given wager.

In one preferred form of the invention, a player makes a wager in a progressive game through a player station 103, and this wager is communicated to the respective local area server 114 with information making up a game play request. The prize manager processes (414 in FIGS. 4 and 5) executed at the respective local area server 114 then use this received wager information to perform the remaining steps of the prize contribution process shown in FIG. 7. In other configurations within the scope of the invention, a central component such as one of the central game servers 105 or 106 might provide wager information to the central prize manager processes 404 and local prize manager processes 414.

A preferred form of the present invention associates each wager for a particular progressive game with a contribution table entry identifier for the contribution table entry (510 in FIG. 5) to be used for that wager. For example, a given game play request initiated from a given player station may prompt local prize manager processes 414 to conduct a look up in a suitable data structure maintained by local database processes 415 relating game play request characteristics such as a player station ID or game ID, for example, with a contribution table entry identifier and thus a particular contribution table entry 510. Alternatively, a given game play request itself may include a contribution table entry identifier associating the wager with a contribution table entry 510. In any event, the contribution table identifier is used to locate the proper contribution table entry 510 in contribution table 502. The progressive prize pool to which the wager applies may then be determined from the progressive pool identifier contained in the identified contribution table entry 510. Once the local area server 114 receives a game play request and the associated wager in a progressive game, the local prize manager processes 414 (FIG. 4) executed at the local area server 114 use the contribution table identifier associated with the wager to look up the corresponding contribution table entry 510 in contribution table 502. The prize manager processes 414 then read the appropriate contribution definition information from the contribution table entry 510, including the progressive prize pool identifier which identifies the progressive prize pool and progressive prize pool entry 501 to which the wager applies and also all information which is used to determine the applicable contribution amount. For example, if the prize contribution is defined as 1 percent of the wager, and the contribution table entry 511 indicates that the progressive prize pool is expressed in a unit of currency, the prize manager processes 414 simply multiply the wager amount expressed in the unit of currency by 0.01 to determine the applicable contribution amount for the progressive pool. If the prize contribution is defined as 1 percent of the wager in this example, and the contribution table entry 511 indicates that the progressive prize pool is expressed in gaming system credits, the prize manager processes 414 determine that the applicable contribution amount is the entire credit wager to arrive an incremental credit amount which will be used to increment the progressive prize pool by one credit each time one hundred credits are wagered in the respective progressive game.

The particular actions taken to update the respective progressive prize pool as indicated at process block 703 will depend upon a number of factors and system implementation details. However, in each case the prize manager processes 414 executing at the respective local area server 114 first access or locate the particular progressive prize pool entry 501 identified for the wager as indicated in block 702. The prize manager processes 414 then apply the contribution definition information from the contribution table entry 511 to update the particular progressive prize pool affected by the wager received at block 701. Continuing on with the earlier example in which the contribution amount comprises simply 1 percent of the wager amount and the prize pool is maintained in a unit currency, the prize manager processes 414 calculate 1 percent of the wager amount in the given currency and add that amount to the value of the prize pool stored in the pool state data field 507 of the respective prize pool table entry 505. Any other applicable fields or values in the prize pool table entry 505 may also be incremented. In the earlier example in which the contribution amount comprises 1 percent of the wager amount and the prize pool is maintained in gaming system credits, the prize manager processes 414 preferably simply add the wager amount to a current incremental amount stored in the pool state data field of the respective prize pool entry 505. If the incremental amount goes over one hundred, the prize manager processes 414 increment the current credit value of the prize pool by one credit and store remaining credit value in the incremental value field after deducting one hundred credits.

The actions taken at process block 703 are particularly affected by whether the particular progressive game is a system-wide progressive game or a progressive game available only through a single game site system 102. Where a progressive game is not a system-wide game, it may only be necessary to access to the applicable prize pool table entry 505 of the prize pool table 501 stored at the local database system 115 in order to properly update the prize pool. However, if a prize pool receives contributions from player stations 103 at different gaming site systems 102, that is, where the progressive game is a system-wide progressive, additional steps may be required to update the prize pool information stored in table 601 at central database system 108. Updating a system-wide progressive prize pool may be handled in a number of different fashions within the scope of the present invention. In one preferred form of the invention, each local database system maintains a respective prize pool table entry 505 for a system-wide prize pool. This local prize pool table entry 505 is used to collect prize pool contribution information temporarily pending transfer of the data the corresponding prize pool entry 605 at central database system 108. The central prize manager processes 404 operating at the central system 101 may periodically poll the local database systems for system-wide prize pool information. Alternatively, the local prize manager processes 414 operating at the gaming site systems 102 may periodically push system-wide progressive data to the central database system for updating the applicable prize pool table entry 605 for the respective system-wide prize pool. For example, a preferred system may forward locally collected data on system-wide progressive prize pools to the central prize manager processes 404 once every minute or every one hundred dollars of sales, which ever occurs first. Central prize manager processes 404 then update the respective progressive prize pool indicated with the forwarded information. Other preferred forms of the invention push locally collected system-wide prize pool update information directly to central database system 108 on every wager so that central prize manager processes 404 operating at central system 101 may update the central database prize pool table 601. This a latter arrangement may obviate the need for local progressive prize pool table entries 505 for system-wide progressive games.

Referring to FIG. 8, the process of awarding prizes from the progressive prize pools according to the present invention includes first receiving a potential progressive prize-winning result as shown at block 801 in FIG. 8. The method then includes comparing this potential progressive prize-winning result with the entries in the award table as indicated at process block 802, in order to identify whether the received result represents a progressive prize winner. If the result at decision block 803 is negative, that is, the result is not a progressive prize winner, the process simply ends. However, if the result is determined to be a progressive prize winner, the process continues on to process block 804. At this point, the method includes identifying the applicable progressive prize from the award tables 503 and/or 603 described with reference to FIGS. 5 and 6. The method may also require a final prize update for the progressive prize as indicated at process block 805. In any event, once the applicable progressive pool prize has been identified from the applicable data structures, the invention includes assigning the progressive prize to the winning player as shown at process block 806, and updating the applicable progressive prize pool as shown at process block 807. The process then ends for that particular result.

In gaming system 100 shown in FIG. 1, the results for a given game play request are identified by the appropriate central game server 105 or 106, or potentially a respective local area server 114. The step shown at process block 801 in FIG. 8 includes receiving the result from the particular central game server or local area server. In a preferred implementation of the invention, the step of receiving the result includes either communicating the result from the particular central game server 105 or 106 to the respective local area server 114 responsible for returning the result to the player station 103, or simply identifying the result at the local area server 114 operating as a result identifying component. In the later case the result is received when it is made available at the local area server.

The comparison step shown at process block 802 in FIG. 8 preferably includes comparing information regarding the given result with the award table entries 515 and/or 615 depending upon implementation specifics. A match between the result information and the progressive prize award definition stored in an entry in the award table 503 or 603 indicates that the result is a progressive prize winner. For example, a progressive prize win may be defined for a bingo game as a particular pattern achieved using some maximum number of balls from the bingo ball draw and the award tables 503 and 603 will include an entry 515/615 that stores an identifier for the progressive winning pattern and a value for the maximum number of balls to produce the pattern. In this example, the potential prize winning result information will include a pattern identifier and the number of balls required to produce that pattern, and this information is compared to the table entries to determine a match. As another example, a progressive prize win may be defined as a particular poker hand in a poker game and this definition would be stored in the form of a poker hand identifier in an award table entry. In this example, the result information for a given result in the poker game would include an identifier for the poker hand achieved in the game and this identifier would be compared to the award table entries to see if the identifier matches the stored identifier. Such a match would indicate that the result being compared represents a progressive prize win.

In a preferred implementation of the invention, the comparison indicated at block 802 is performed first with the local prize manager processes 414 receiving the result. If the comparison at block 802 is negative or if the result shows a local progressive prize winner there may be no result comparison at the central prize manager processes 404. As discussed below, in these cases, all of the information necessary to identify and award the local progressive prize is available at the gaming site system 102 through local prize manager processes 414 and local database processes 415.

If the result of the comparison at process block 802 is negative, and there is no match between the received result and a progressive prize winning result as defined in an award table entry 515 or 615, then the progressive prize awarding process ends as to the result received at block 801 in FIG. 8. However, if there is a match, that match identifies a particular award table entry 515 or 615 that defines the progressive prize to be awarded, either directly such as with a fixed progressive prize, or indirectly by reference to a particular prize pool. In cases where the progressive prize is directly defined as some fixed amount or some amount calculated according to some algorithm, looking up the applicable progressive prize as indicated at process block 804 in FIG. 8 includes simply reading the fixed progressive prize value from the particular award table entry or applying the award algorithm to determine the prize value. However, where the progressive prize is defined as the value of a given progressive prize pool at the time of the result, or some percentage of the progressive prize pool value at the time of the result, determining the applicable progressive prize may include performing a final update for the value of the progressive prize pool as indicated a process block 805. This final update is particularly applicable for system-wide progressive prizes where the contribution information is collected at a central location such as central database system 108 from contribution information that is initially stored locally at the various gaming site systems 102.

The actions taken to assign the progressive prize as indicated at process block 806 in FIG. 8 will depend upon the nature of the progressive prize. For system-wide progressive prizes, the prizes are assigned at the central system 101 after appropriate progressive prize pool updates have been performed by collecting information from the various gaming site systems 102, and the prize value and perhaps other information is communicated from the central system 101 to the gaming site system from which the game play request achieving the result originated. Ultimately, the result for the game play request and system-wide progressive prize value are communicated to the player station 103 from which the game play request originated. In a preferred implementation, the result and prize communication is from the central game server such as server 105 or 106 in FIG. 1, to the respective local area server 114 at the proper gaming site system 102, and then to the game play request originating player station 103.

In contrast to system-wide progressive prizes, local progressive prizes are preferably assigned by the local prize manager processes 414 performed at the respective gaming site system 102 where the winning game play request originated. This is possible because the progressive prize win is detected through award table data stored at the local database system 115 and the progressive prize value is obtained from progressive prize pool data stored at the local database system as well. In the case of a result that represents a local progressive prize win, the result is returned to the gaming site system 102 from the respective central game server 105 or 106, or simply made available at the local area server 114 where the local area server identifies the result, and the local prize manager processes 414 executing at the gaming site system perform the prize value look up indicated at process block 804. The local area server 114 then communicates the progressive prize value back to the game play request originating player station 103 either with the game result itself or as a separate communication.

Regardless of how the progressive prizes are assigned, the process includes updating the affected progressive prize pool or pools upon assigning a progressive prize. For example, where the assigned progressive prize is a fixed value, the value of the progressive prize pool from which the fixed progressive prize is awarded is simply debited by the amount of the assigned progressive prize value. Where the prize value for the progressive prize is defined as the entire pool value at the time of the result, updating the progressive prize pool as shown at block 807 in FIG. 8 involves reducing the prize pool by the entire value of the prize pool at the time of the result. In some cases, a seed value or minimum prize pool value may be added back as the current prize pool value.

The form of the invention described above and illustrated especially in FIG. 4 may be varied significantly within the scope of the present invention. In an alternative embodiment, much if not all of the processes associated with the progressive games and progressive game data may be handled through a central processing system. For example, a gaming system within the scope of the present invention may be configured so that all game play requests are ultimately directed to a central game server such as 105 and 106 in FIG. 1. In this case, the central system 101 will have all wager information for both local progressive games available only at a single gaming site system 102, and for system-wide progressive games. Thus, the central prize manager processes 404 may handle all contributions and all awards from all progressive prize pools and there would be no local prize manager processes 414 or local database processes for progressive prize pool information.

The timing of a game play request in a progressive game affects the progressive prize that may be available where the progressive prize value to be awarded is expressed in terms of the total value of the respective progressive prize pool at the time of the game play request or at the time of the result in the game. For example, a progressive prize pool may collect for some time before a first player receives a progressive prize winning result for that progressive prize pool, and a second player may receive a progressive prize winning result for that progressive prize pool shortly after the first player's winning result. In this case the first player may receive the large prize pool value and the second player may receive only a minimum prize pool value.

There may be situations in which two or more different players submit game play request at very near the same time and each obtain a progressive prize winning result for the same progressive prize. It is possible to implement the present progressive gaming system using time stamps for the various game play requests, and award progressive prizes strictly based on the timing of the various game play requests and the actual value of the progressive prize pools at the time of a game play request that results in a win. A problem with this sort of implementation is that the progressive prize pool values that may be displayed at a player station may not be updated quickly enough to reflect a lower prize pool at the time a second winning player makes their game play request. In this situation strictly applying the game pay request timing and prize pool value, a player may be progressive prize winner but not be awarded the value of the progressive prize pool displayed at their player station at the time of their game play request. Thus, some preferred forms of the present progressive gaming system may not strictly apply the game play request timing and progressive prize value at the time of the request. In one preferred implementation a critical period is defined as the time that a player places a wager (makes a game play request) and the time that the progressive prize is assigned for that game play request. If a second player achieves the same progressive prize winning result in this time period for a first player, then the system is preferably configured to assign both players the progressive prize value displayed on their player station 103 at the time they made their game play request.

As used herein, whether in the above description or the following claims, the terms “comprising”, “including”, “carrying”, “having”, “containing”, “involving”, and the like are to be understood to be open-ended, that is, to mean including but not limited to. Only the transitional phrases “consisting of” and “consisting essentially of,” respectively, shall be closed or semi-closed transitional phrases, as set forth, with respect to claims, in the United States Patent Office Manual of Patent Examining Procedures (Eighth Edition, August 2001 as revised May 2004), Section 2111.03.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The above described preferred embodiments are intended to illustrate the principles of the invention, but not to limit the scope of the invention. Various other embodiments and modifications to these preferred embodiments may be made by those skilled in the art without departing from the scope of the present invention. For example, the data structures shown in FIGS. 5 and 6 may vary greatly within the scope of the present invention. In particular, the data shown stored in the various data table entries may be distributed across several different data structures. The invention encompasses any arrangement for storing the correlated prize pool, contribution definition, and award definition information.

1. A method including:
(a) storing a number of contribution definitions, each respective contribution definition being associated with a respective progressive prize pool included in a number of progressive prize pools;
(b) identifying a first contribution definition included in the number of contribution definitions, the first contribution definition being identified based on a first game play request to which the first contribution definition is correlated; and
(c) applying the first contribution definition to update the respective progressive prize pool associated with the first contribution definition.

2. The method of claim 1 further including:
(a) identifying a second contribution definition included in the number of contribution definitions, the second contribution definition being different from the first contribution definition and being identified based on a second game play request to which the second contribution definition is correlated; and
(b) applying the second contribution definition to update the respective progressive prize pool associated with the second contribution definition.

3. The method of claim 2 wherein both the first game play request and the second game play request are entered for a first game presentation.

4. The method of claim 1 further including:
(a) identifying a respective contribution definition included in the number of contribution definitions, the respective contribution definition being associated with the same progressive prize pool as the first contribution definition, being different from the first contribution definition, and being identified based on a second game play request to which the respective contribution definition is correlated; and
(b) applying the respective one of the contribution definitions to update the respective progressive prize pool associated with the first contribution definition; and
(c) wherein the first game play request is entered for a first game presentation and the second game play request is entered for a second game presentation different from the first game presentation.

5. The method of claim 1 further including:
(a) identifying a second contribution definition associated with the same respective progressive prize pool associated with the first contribution definition, the second contribution definition being identified based on a second game play request with which the second contribution definition is correlated; and
(b) applying the second contribution definition to update the respective progressive prize pool associated with the first contribution definition and second contribution definition.

6. The method of claim 5 wherein the first game play request is for a first denomination game and the second game play request is for a second denomination game have a different denomination than the first denomination game.

7. The method of claim 5 further including processing the first game play request with a first result determining component and processing the second game play request with a second result determining component, different from the first result determining component.

8. The method of claim 1 further including:
(a) storing a number of award definitions, each respective award definition being associated with a respective progressive prize pool included in the number of progressive prize pools; and
(b) identifying a first award definition included in the set of the award definitions, the first award definition being identified based on a first game result with which the first award definition is correlated; and
(c) applying the first award definition to assign a first prize from the progressive prize pool associated with the first award definition and to update that progressive prize pool.

9. The method of claim 8 further including:
(a) identifying a second award definition included in the set of award definitions, the second award definition being associated with the same respective progressive prize pool with which the first award definition is associated and being identified based on a second game result with which the second award definition is correlated; and
(b) applying the second award definition to assign a second prize from the progressive prize pool associated with the first award definition and to update that progressive prize pool.

10. The method of claim 9 further including displaying the first prize to a first player through a first game presentation and displaying the second prize to a second player through a second game presentation different from the first game presentation.

11. A method including:
(a) storing a number of award definitions, each respective award definition being associated with a respective progressive prize pool; and
(b) identifying a first award definition included in the number of the award definitions, the first award definition being identified based on a first game result with which the first award definition is correlated; and
(c) applying the first award definition to assign a prize from the respective progressive prize pool associated with the first award definition and to update that progressive prize pool.

12. The method of claim 11 further including:
(a) identifying a second award definition included in the set of award definitions, the second award definition being associated with the same respective progressive prize pool with which the first award definition is associated and being identified based on a second game result with which the second award definition is correlated; and
(b) applying the second award definition to assign a second prize from the progressive prize pool associated with the first award definition and to update that progressive prize pool.

13. The method of claim 12 further including displaying the first prize to a first player through a first game presentation and displaying the second prize to a second player through a second game presentation different from the first game presentation.

14. A gaming system including:
(a) a number of player stations;
(b) a database system storing a number of progressive prize pool entries and a number of contribution definitions, each contribution definition being associated with a respective one of the progressive prize pool entries; and
(c) a game processing system for receiving a first game play request from a first player station included in the number of player stations and for interfacing with the database system to identify a first contribution definition included in the number of contribution definitions and to apply the first contribution definition to update the respective progressive prize pool entry associated with the first contribution definition, the first contribution definition being identified based on the first game play request.

15. The gaming system of claim 14 wherein:
(a) the game processing system is also for receiving a second game play request from a second player station included in the number of player stations and for interfacing with the database system to identify one of the contribution definitions included in the number of contribution definitions and to apply the one of the contribution definitions to update the respective progressive prize pool entry associated with the first contribution definition, the one of the contribution definitions being identified based on the second game play request; and
(b) the first player station provides a first game presentation and the second player station provides a second game presentation different from the first game presentation.

16. The gaming system of claim 14 wherein:
(a) the game processing system is also for receiving a second game play request from a second player station included in the number of player stations and for interfacing with the database system to identify a second contribution definition included in the number of contribution definitions and to apply the second contribution definition to update a respective progressive prize pool entry which is different from the progressive prize pool entry associated with the first contribution definition, the second contribution definition being identified based on the second game play request; and
(b) the first player station and the second player station both provide a common game presentation.

17. The gaming system of claim 14 further including:
(a) a number of additional player stations; and
(b) an additional game processing system for receiving an additional game play request from a first additional player station included in the number of additional player stations and for interfacing with the database system to identify an additional contribution definition included in the number of contribution definitions and to apply the additional contribution definition to update the respective progressive prize pool entry associated with the additional contribution definition, the additional contribution definition being identified base on the additional game play request.

18. The gaming system of claim 14 wherein:
(a) the database system also stores a number of award definitions, each award definition being associated with a respective one of the progressive prize pool entries; and
(b) the game processing system is also for identifying a game result for the first game play request and for interfacing with the database system to identify a first award definition included in the number of award definitions and to apply the first award definition to assign a first prize from the progressive prize pool associated with the first award definition and to update that progressive prize pool, the first award definition being identified based on the first game result.

19. A program product stored on one or more computer readable media, the program product including:
(a) prize database program code for storing a number of contribution definitions, each respective contribution definition being associated with a respective progressive prize pool included in a number of progressive prize pools; and
(b) prize manager program code that is executable to identify a first contribution definition included in the number of contribution definitions, and to apply the first contribution definition to update the respective progressive prize pool associated with the first contribution definition, the first contribution definition being identified based on a first game play request with which the first contribution definition is correlated.

20. The program product of claim 19 wherein the prize manager program code is also executable to identify a second contribution definition included in the number of contribution definitions and different from the first contribution definition, and to apply the second contribution definition to update the respective progressive prize pool associated with the second contribution definition, the second contribution definition being identified based on a second game play request with the second contribution definition is correlated.

21. The program product of claim 20 wherein both the first game play request and the second game play request are entered for a first game presentation.

22. The program product of claim 19 wherein:
(a) the prize manager program code is also executable to identify a respective one of the contribution definitions associated with the same progressive prize pool as the first contribution definition, and to apply the respective one of the contribution definitions to update the respective progressive prize pool associated with the first contribution definition, the respective one of the contribution definitions being identified based on a second game play request with which the respective contribution definition is correlated; and
(b) wherein the first game play request is entered for a first game presentation and the second game play request is entered for a second game presentation different from the first game presentation.

23. The program product of claim 19 wherein the prize manager program code is also executable to identify a second contribution definition associated with the same respective progressive prize pool associated with the first contribution definition, and to apply the second contribution definition to update the respective progressive prize pool associated with the first contribution definition and second contribution definition, the second contribution definition being identified based on a second game play request with which the second contribution request is identified.

24. The program product of claim 23 wherein the first game play request is for a first denomination game and the second game play request is for a second denomination game have a different denomination than the first denomination game.

25. The program product of claim 19 wherein:
(a) the prize database program code is also executable to store a number of award definitions, each respective award definition being associated with a respective progressive prize pool included in the number of progressive prize pools; and
(b) the prize manager program code is also executable to identify a first award definition included in the set of the award definitions, and to apply the first award definition to assign a first prize from the progressive prize pool associated with the first award definition and to update that progressive prize pool, the first award definition being identified base on a first game result with which the first award definition is correlated.

26. The program product of claim 25 wherein the prize manager program code is also executable to identify a second award definition included in the set of award definitions, the second award definition being associated with the same respective progressive prize pool with which the first award definition is associated, and to apply the second award definition to assign a second prize from the progressive prize pool associated with the first award definition and to update that progressive prize pool, the second award definition being identified based on a second game result with which the second award definition is correlated.

27. The program product of claim 26 further including:
(a) first player station program code that is executable to display the first prize to a first player through a first game presentation; and
(b) second player station program code that is executable to display the second prize to a second player through a second game presentation different from the first game presentation.
